(19) United States
(12) Patent Application Publication
(10) Pub. No.: US 2019/0136617 A1
(43) Pub. Date: May 9, 2019

(54) CORDLESS PUSH-PULL ROLLER BLIND MECHANISM

(71) Applicant: UNI-SOLEIL ENT. CO., LTD., TAINAN CITY (TW)

(72) Inventor: YU-TING KAO, TAINAN CITY (TW)

(21) Appl. No.: 15/804,155

(22) Filed: Nov. 6, 2017

(51) Int. Cl. E06B 9/60; E06B 9/44; E06B 9/42; E06B 9/78

(52) U.S. Cl. CPC E06B 9/60; E06B 9/78; E06B 9/42; E06B 9/44

(57) ABSTRACT

The present invention relates to a cordless push-pull roller blind mechanism comprising a roller blind holder, a shaft tube controller, and a locating buffer. The roller blind holder includes a fixing frame; two fixing brackets disposed on two sides of the fixing frame, wherein each of the two fixing brackets is provided with a shaft seat on an inner surface thereof and a connecting portion in the shaft seat; two shaft tube sleeves disposed on the two shaft seats, wherein each of the two shaft tube sleeves is provided with an inserting portion for assembling to the connecting portion; a shaft tube dispose between the two shaft tube sleeves for accommodating the shaft tube controller and the locating buffer; and a roller blind wound on the shaft tube.

### BACKGROUND OF THE INVENTION

### 1. Field of the Invention

The present invention relates to a cordless push-pull roller blind mechanism which can be pulled and controlled directly and easily for vertical shrinking or extension to desired positions and has effects of convenient and safety in practical use.

### 2. Description of Related Art

With the ever-changing technology and the improvement of living standard, the requirement of living environment quality by people is gradually increased. In regard to the living, all kinds of windows become is an important equipment, because the windows relate not only to the indoor daylight and the ventilation, but also to the windproof and waterproof. Therefore, the improvement of living environment quality really depends on the well-designed windows. A roller blind which is used for covering the window has the functions of pretty, shading and adjusting the intensity of light irradiation. The hue, style and pattern of the roller blind directly affect the overall visual effect of an entire house. When the house is decorated, the roller blind is a key factor that can immediately change an impression of a room and create an atmosphere of happiness by changing the roller blinds with different colors or patterns.

The traditional roller blind structure, e.g. the four Taiwan Patents No. M459814U1 revealing “a roller blind controller”, No. M359285U1 revealing “a cord mechanism of curtain”, No. M317233 revealing “an improved roller blind controller”, and No. 579803 revealing “an improved roller blind controller”, mainly comprises a shaft, a roller blind cloth wound on the shaft, a controller connected to the shaft, and a bead chain wound on the controller. Accordingly, the controller can be driven to rotate the shaft in a clockwise direction or a counterclockwise direction by pulling the bead chain for further controlling the rise or fall of the roller blind cloth.

Although the aforementioned roller blind structure can achieve the expected effect of controlling the roller blind cloth to be raised or is lowered by the bead chain, it still has some disadvantages that need to be solved. In order to sustain a long-term pull by a user for controlling the roller blind cloth to be raised or lowered, the bead chain is shaped with an annular body and has a very high toughness, so the bead chain is unlike to break. In such a case, if children have their necks being wrapped around by the bead chain, the suffocating accident may occur because of the panic and inability of freeing from the bead chain. As a result, the market gradually restricts the use of the bead chain due to the security issue.

### SUMMARY OF THE INVENTION

In view of the above-mentioned problems, the object of the present invention is to provide a cordless push-pull roller blind mechanism that can be controlled be raised or lowered to desired positions by pulling the roller blind and has effects of convenience and safety in practical use.

Disclosed herein is a cordless push-pull roller blind mechanism comprising:

a roller blind holder having a fixing frame, two fixing brackets respectively disposed on two sides of the fixing frame, two shaft tube sleeves comprising a first shaft tube sleeve and a second shaft tube sleeve for respectively assembling to the two fixing brackets, a shaft tube is disposed between the two shaft tube sleeves, and a roller blind wound on the shaft tube, wherein each of the two fixing brackets is provided with a shaft seat on an inner surface thereof and a connecting portion in the shaft seat, and wherein each of the two shaft tube sleeves is provided with an inserting portion relative to the connecting portion in the shaft seat for jointing to the connecting portion;

a polygonal shaft component having one end connected to the first shaft tube sleeve;

a shaft tube controller disposed in the shaft tube of the roller blind holder and having a casing tube at one end thereof for connecting to the second shaft tube sleeve, and an inlaying component movably disposed on the casing tube for engaging with an inner edge of the shaft tube for position, and a spring disposed on an outer edge of the casing tube, wherein the spring is provided with one end connected to the casing tube for fixation and the other end connected to the inlaying component for fixation; and

a locating buffer disposed in the shaft tube of the roller blind holder and having an external casing for engaging with the inner edge of the shaft tube, a joint member disposed in a middle of the external casing and corresponding to the polygonal shaft component connected to the second shaft tube sleeve for connecting to the polygonal shaft component for fixation, and a spring plate wound between an inner edge is of the external casing and the joint member, wherein the spring plate is connected to the inner edge of the external casing at one end thereof for fixation and connected to the joint member at the other end thereof for fixation.

According to an embodiment of the present invention, the shaft tube is further provided with a bump on the inner edge thereof for engaging with the inlaying component of the shaft tube controller and a concave portion formed on the external casing of the locating buffer.

According to an embodiment of the present invention, each of the two fixing brackets of the roller blind holder is provided with an adjustment portion on an outer surface thereof for adjusting and rotating the connecting portion.

According to an embodiment of the present invention, each of the two fixing brackets of the roller blind holder is disposed with a lid on an outer surface thereof.

According to an embodiment of the present invention, the roller blind is provided with a gripping component at a bottom thereof for vertical shrinking or extension thereof by a user.

### BRIEF DESCRIPTION OF THE DRAWINGS

FIG. 1 is an exploded diagram showing a cordless push-pull roller is blind mechanism according to the present invention;

FIG. 2 is a schematic diagram showing a cordless push-pull roller blind mechanism in assembly according to the present invention;

FIG. 3 is a schematic diagram showing a cordless push-pull roller blind mechanism in use according to the present invention.

### DETAILED DESCRIPTION OF THE PREFERRED EMBODIMENT

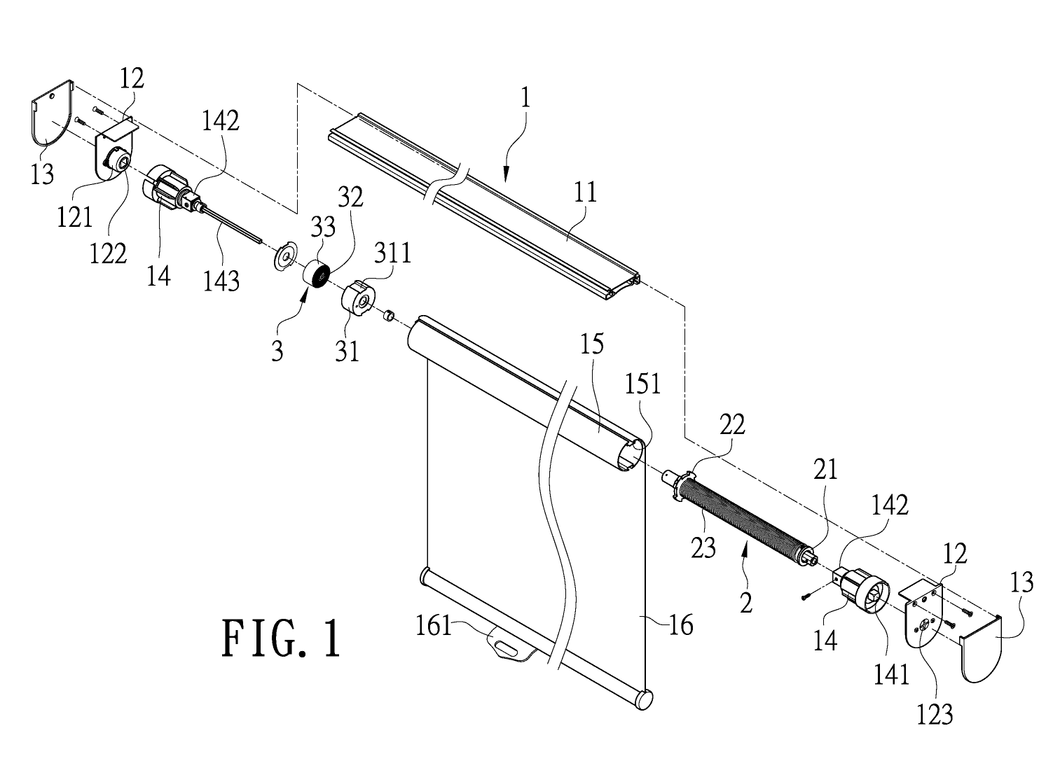

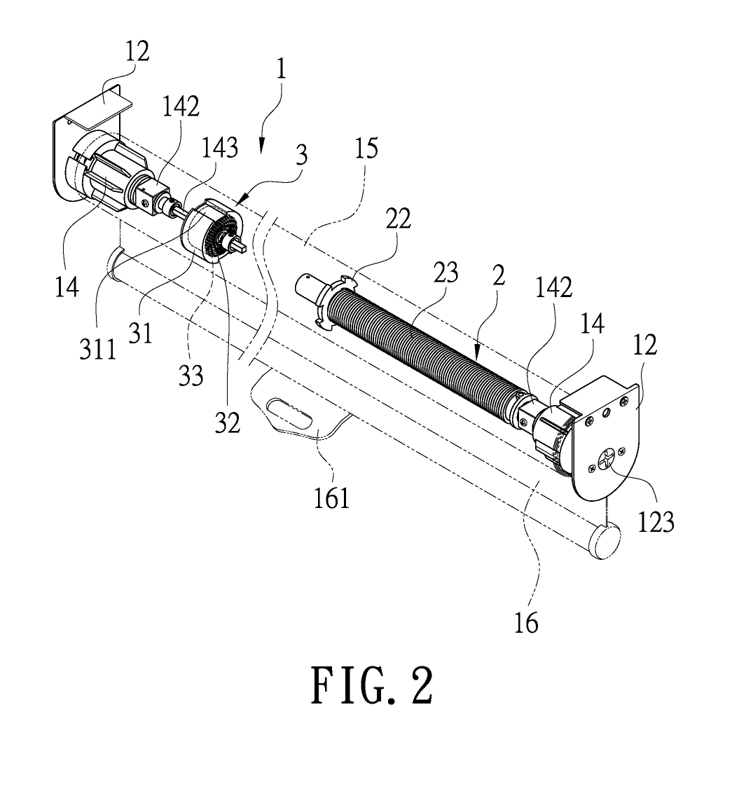

As showed in FIG. 1 and FIG. 2, a cordless push-pull roller blind mechanism disclosed herein mainly comprises a roller blind holder (1), a shaft tube controller (2) and a locating buffer (3).

The roller blind holder (1) having a fixing frame (11), two fixing brackets (12) respectively disposed on two sides of the fixing frame (11), a lid (13) on the outer surface thereof, two shaft tube sleeves (14) comprising a first shaft tube sleeve and a second shaft tube sleeve for respectively assembling to the two fixing brackets (12), a shaft tube (15) disposed between the two shaft tube sleeves (14) and further provided with a bump (151) on an inner edge thereof, and a roller blind (16) wound on the shaft tube (15). Each of the two fixing brackets (12) is provided with a shaft seat (121) on an inner surface thereof for inserting into the each of the two shaft tube sleeves (14), a connecting portion (122) in the shaft seat (121), and an adjustment portion (123) on an outer is surface thereof for adjusting and rotating the connecting portion (122). Each of the two shaft tube sleeves (14) is provided with an inserting portion (141) relative to the connecting portion (122) in the shaft seat (121) for jointing to the connecting portion (122), and an end base (142). The end base (142) on the first shaft tube sleeve (14) is connected to a polygonal shaft component (143), and the end base (142) on the second shaft tube sleeve (14) is connected to the shaft tube controller (2). The roller blind (16) is provided with a gripping component (161) at a bottom thereof for vertical shrinking or extension thereof by a user.

The shaft tube controller (2) is disposed in the shaft tube (15) of the roller blind holder (1) and having a casing tube (21) at one end thereof for connecting to the end seat (142) of the second shaft tube sleeve (14), and an inlaying component (22) movably disposed on the casing tube (21) for engaging with the bump (151) of the inner edge of the shaft tube (15), and a spring (23) disposed on an outer edge of the casing tube (21) The spring (23) is connected to the casing tube (21) at one end thereof for fixation and connected to the inlaying component (22) at the other end for fixation.

The locating buffer (3) is also disposed in the shaft tube (15) of the roller blind holder (1) and provided with an external casing (31), a joint member (32) disposed in a middle of the external casing (31) and corresponding to the polygonal shaft component (143) connected to the second shaft tube sleeve (14) for connecting to the polygonal shaft is component (143) for fixation, and a spring plate (33) wound between an inner edge of the external casing (31) and the joint member (32). The external casing (31) is further provided with a concave portion (311) for engaging with the bump (151) of the inner edge of the shaft tube (15). The spring plate (33) is further connected to the inner edge of the external casing (31) at one end thereof for fixation and connected to the joint member (32) at the other end thereof for fixation.

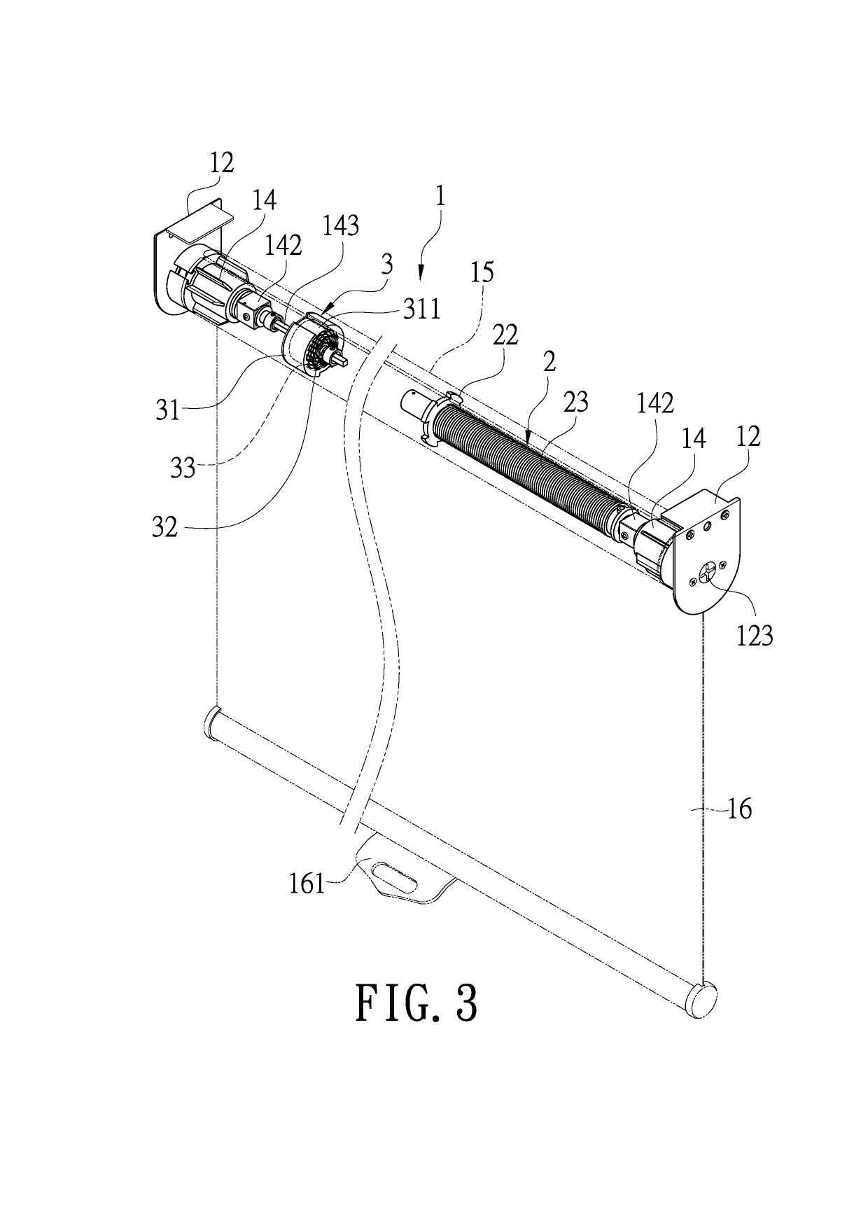

Accordingly, as shown in FIG. 3, the casing tube (21) of the shaft tube controller (2) is connected to the end seat (142) of the second shaft tube sleeve (14) disposed on the fixing brackets (12) for fixation, and the joint component (32) of the locating buffer (3) is disposed on the polygonal shaft component (143) of the first shaft tube sleeve (14) The shaft tube controller (2) and the locating buffer (3) are disposed in the shaft tube (15) of the roller blind holder (1). The inlaying component (22) of the shaft tube controller (2) and the concave portion (311) of the external casing (31) of the locating buffer (3) are respectively engaged with the bump (151) on the inner edge of the shaft tube (15). The amount of the locating buffer (3) is adjusted depending on a weight of the winded roller blind (16). Specifically, the elastic force of the spring plate (33) of the locating buffer (3) is approximately equal to the weight of the roller blind (16) added with the elastic force of the spring (23) disposed on the outer edge of the casing tube (21) of the shaft tube controller (2). Accordingly, the shaft tube (15) rotates between the two shaft tube is sleeves (14) when a user pulls the roller blind (16) downwardly. The rotation of the shaft tube (15) further drives the inlaying component (22) of the shaft tube controller (2) engaged with the shaft tube (15) and the external casing (31) of the locating buffer (3) to rotate. Meanwhile, the spring (23) and the spring plate (33) are respectively driven to rotate by the inlaying component (22) and the external casing (31) for storing energy. If the user stops pulling the roller blind (16), the roller blind (16) keeps in a stationary status because the elastic force of the spring plate (33) of the locating buffer (3) is equal to the weight of the roller blind (16) added with the elastic force of the spring (23) disposed on the outer edge of the casing tube (21) of the shaft tube controller (2). If the user pushes the roller blind (16) upwardly by hands, the spring (23) and the spring plate (33) release the stored energy to drive the shaft tube (15) to rotate in a counterclockwise direction. In such a case, the roller blind (16) can be wound on the shaft tube (15) effortlessly and quickly and can remain stationary in a predetermined position by the user.

In addition, each of the two fixing brackets (12) of the roller blind holder (1) is provided with the adjustment portion (123) on the outer surface thereof relative to the connecting portion (122) for adjusting and rotating the connecting portion (122) and for further driving the inserting portions (141) connected to the connecting portions (122) to rotate. Accordingly, the casing tube (21) and the joint member (32) can be rotated by the casing tube (21) or the polygonal shaft component (143) is which are respectively connected to the inserting portions (141) to adjust the initial shrinking position of the roller blind (16) for completely winding on the shaft tube (15).

Therefore, in comparison with the conventional structure, the cordless push-pull roller blind mechanism of the present invention having a roller blind to be pulled directly and easily for lowering downwardly or shrinking upwardly to desired positions has effects of convenience and safety in practical use.

What is claimed is:

1. A cordless push-pull roller blind mechanism comprising:
a roller blind holder having a fixing frame, two fixing brackets respectively disposed on two sides of the fixing frame, two shaft tube sleeves comprising a first shaft tube sleeve and a second shaft tube sleeve for respectively assembling to the two fixing brackets, a shaft tube disposed between the two shaft tube sleeves, and a roller blind wound on the shaft tube, wherein each of the two fixing brackets is provided with a shaft seat on an inner surface thereof and a connecting portion in the shaft seat, and wherein each of the two shaft tube sleeves is provided with an inserting portion relative to the connecting portion in the shaft seat for jointing to the connecting portion;
a polygonal shaft component having one end connected to the first is shaft tube sleeve;
a shaft tube controller disposed in the shaft tube of the roller blind holder and having a casing tube at one end thereof for connecting to the second shaft tube sleeve, and an inlaying component movably disposed on the casing tube for engaging with an inner edge of the shaft tube for position, and a spring disposed on an outer edge of the casing tube, wherein the spring is provided with one end connected to the casing tube for fixation and the other end connected to the inlaying component for fixation; and
a locating buffer disposed in the shaft tube of the roller blind holder and having an external casing for engaging with the inner edge of the shaft tube, a joint member disposed in a middle of the external casing and corresponding to the polygonal shaft component connected to the second shaft tube sleeve for connecting to the polygonal shaft component for fixation, and a spring plate wound between an inner edge of the external casing and the joint member, wherein the spring plate is connected to the inner edge of the external casing at one end thereof for fixation and connected to the joint member at the other end thereof for fixation.

2. The cordless push-pull roller blind mechanism claimed in claim 1, wherein the shaft tube is further provided with a bump on the inner edge thereof for engaging with the inlaying component of the shaft tube controller and a concave portion formed on the external casing is of the locating buffer.

3. The cordless push-pull roller blind mechanism claimed in claim 1, wherein each of the two fixing brackets of the roller blind holder is provided with an adjustment portion on an outer surface thereof for adjusting and rotating the connecting portion.

4. The cordless push-pull roller blind mechanism claimed in claim 1, wherein each of the two fixing brackets of the roller blind holder is disposed with a lid on an outer surface thereof.

5. The cordless push-pull roller blind mechanism claimed in claim 1, wherein the roller blind is provided with a gripping component at a bottom thereof for vertical shrinking or extension thereof by a user.

6. The cordless push-pull roller blind mechanism claimed in claim 3, wherein each of the two fixing brackets of the roller blind holder is disposed with a lid on the outer surface thereof.
